(19) United States
(12) Patent Application Publication
(10) Pub. No.: US 2020/0215669 A1
(43) Pub. Date: Jul. 9, 2020

(54) Adjusting and Positioning Device for Wooden Boards

(71) Applicant: Hwally Products Co., Ltd., Taichung City (TW)

(72) Inventor: Wang-Kuan Lin, Taichung City (TW)

(21) Appl. No.: 16/242,889

(22) Filed: Jan. 8, 2019

(51) Int. Cl. B25B 23/00; B25B 23/08

(52) U.S. Cl. CPC B25B 23/005; B25B 23/08

(57) ABSTRACT

An adjusting and positioning device for wooden boards includes a first part and a second part. A cover unit is movably connected between the first and second parts. A driving unit is connected with the cover unit. An activation member is engaged with the toothed portions of two racks of the driving unit. A sleeve includes a shaft that movably extends through the sleeve. The shaft includes spiral teeth, and two arms are threadedly engaged with the spiral teeth. The arms are pivotably connected with two clamp members which are slidably connected to a base. When the first part and the second part are gripped by a user, and the cover unit is pressed, the shaft is moved to pivot the arms which drive the clamp members to move along the guide grooves of the base to control a distance between two adjacent boards by one hand.

### BACKGROUND OF THE INVENTION

### 1. Fields of the Invention

The present invention relates to an adjusting and positioning device for wooden boards.

### 2. Descriptions of Related Art

A tool for installation of wooden boards known to applicant is disclosed in U.S. Pat. No. 9,120,214, and includes a fastener installation tool comprising a primary housing, including an exterior surface adapted and contoured for manual gripping by a user's hand. A secondary housing moveable is located relative to the primary housing during a fastener installation operation. A drive element. An elongated shaft defines a shaft bore and is joined with at least one of the primary housing and the secondary housing. The shaft bore is configured to receive the drive element when the drive element is rotated by a drive tool. The shaft bore is bounded by a wall. A guide is joined with the elongated shaft, and the guide defines an angled bore configured to receive a fastener. The guide has an exit opening from which the fastener exits the angled bore. The guide includes an alignment projection extending downwardly from the guide a preselected distance. The guide includes a bottom surface configured to engage an uppermost surface of a board to assist in aligning the angled bore with a board side surface at a preselected angle. The angled bore is aligned with the shaft bore so that the drive element can be reciprocally extended through the shaft bore and through the angled bore while rotating the fastener.

When the wooden boards have a wider width, the screw and the nut on the right side so as to move the spacer plate to the right, and then the screw is tightened again. In other words, the adjustment has to be completed by two hands stage by stage. This consumes too much time and has a low efficiency when installing the wooden boards.

The present invention is intended to provide an adjusting and positioning device that is designed to eliminate the drawbacks mentioned above.

### SUMMARY OF THE INVENTION

The present invention relates to an adjusting and positioning device for wooden boards and comprises a first part and a second part. A cover unit is movably connected between the first and second parts. A driving unit is connected with the cover unit. An activation member is engaged with the toothed portions of two racks of the driving unit. A sleeve includes a shaft that movably extends through the sleeve. The shaft includes spiral teeth, and two arms are threadedly engaged with the spiral teeth. The arms are pivotably connected with two clamp members which are slidably connected to a base. When the first part and the second part are gripped by a user, and the cover unit is pressed, the shaft is moved to pivot the arms which drive the clamp members to move along the guide grooves of the base to control a distance between two adjacent boards by one hand.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the adjusting and positioning device of the present invention;

FIG. 2 is a cross sectional view of the adjusting and positioning device of the present invention;

FIG. 3 is a cross sectional view of the adjusting and positioning device wherein the activation member the of the present invention is pushed, and

FIG. 4 is a cross sectional view of the adjusting and positioning device wherein the distance between the two extension portions of the clamp members are adjusted.

### DETAILED DESCRIPTION OF THE PREFERRED EMBODIMENT

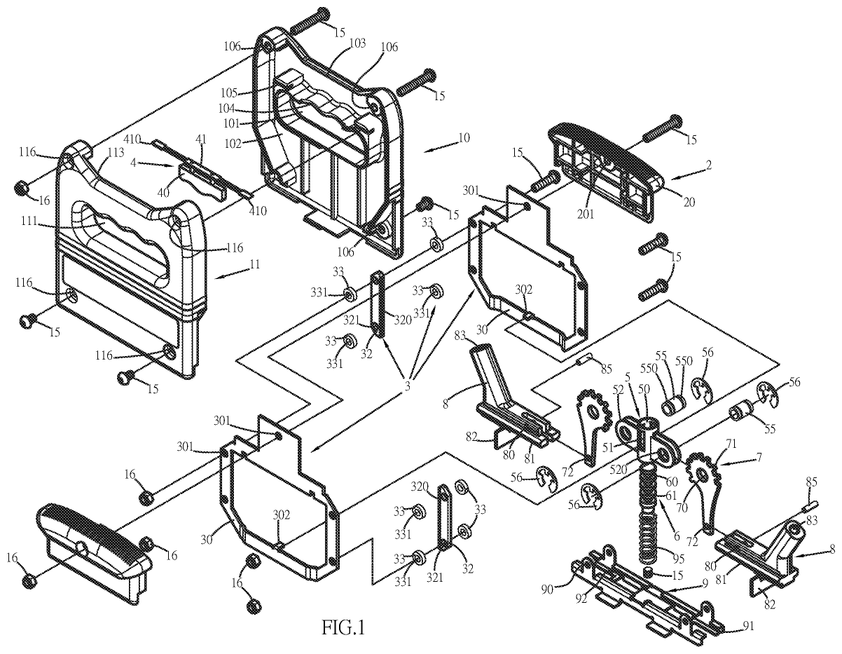

Referring to FIGS. 1 to 4, the adjusting and positioning device of the present invention comprises a first part 10 having a first slot 101 which is designed for manual gripping by a user' hand. A first space 102 is defined in the first part 10, and a driving unit 3 is movably located in the first space 102. A first top groove 103 is defined in the outside of the first part 10 and communicates with the first space 102. A cover unit 2 is movably engaged with the first top groove 103. A first face groove 104 is defined in the first part 10 and communicates with the first space 102 and the first slot 101. An activation member 4 is movably located in the first face groove 104. The activation member 4 has a restriction member 41 which is movably located in two first positioning grooves 105 defined in the first part 10. The first part 10 includes a hole 106 defined through each of four corners thereof.

A second part 11 is connected to the first part 10 so that a portion of the cover unit 2, the driving unit 3, a portion of the activation member 4, a sleeve 5, a shaft 6, two arms 7, two clamp members 8 and a base 9 are accommodated between the first and second part 10, 11. The second part 11 is shaped and structured symmetrical to the first part 10 and includes a second slot 111 configured for manual gripping by the user' hand. A second space (not shown) is defined in the second part 11 and the driving unit 3 is movably located in the second space. A second top groove 113 is defined in the outside of the second part 11 and communicates with the second space. The cover unit 2 is movably engaged with the second top groove 113. A second face groove (not shown) is defined in the second part 11 and communicates with the second space and the second slot 111. The activation member 4 is movably located in the second face groove. The restriction member 41 of the activation member 4 is movably located in the two second positioning grooves (not shown) defined in the second part 11. The second part 11 has a hole 116 defined through each of four corners thereof. Multiple bolt 15 respectively extend through the first holes 106 of the first part 10 and the second holes 116 of the second part 11, and are connected with nuts 16 to connect the first part 10 to the second part 11.

The cover unit 2 has one end thereof movable between the first top groove 103 of the first part 10 and the second top groove 113 of the second part 11. In this embodiment, the cover unit 2 includes two identical covers 20, and each cover 20 includes a fixing hole 201 which is located corresponding to the positioning hole 301 of the driving unit 3. A bolt 15 extends through the fixing holes 201 and the positioning holes 301, and is connected to a nut 16 to connect the two covers 2 with the driving unit 3.

The driving unit 3 includes multiple positioning holes 301 defined in one end thereof so as to be connected to the cover unit 2. The driving unit 3 has a driving portion 302 protruding from the other one of the driving unit 3 so as to drive the shaft 6 in the sleeve 5. Two toothed portions 320 are respectively formed in the driving unit 3 to be engaged with the activation member 4. In this embodiment, the driving unit 3 includes two elongated racks 32 and two identical frames 30. Multiple plastic washers 33 are clamped between the rack 32 and the frame 30. Each frame 30 has the positioning holes 301 and the driving portion 302 which extends inward therefrom. Each rack 32 includes the toothed portion 320 formed in the inner side thereof, and an aperture 321 is defined through each of two ends of the rack 32. Each plastic washer 33 includes a central hole 331. The two racks 32 and the sleeve 5 are located between the two frames 30. The bolts 15 extend through the positioning holes 301 of the two frames 30, the central holes 331 of the plastic washers 33 and aperture 321 defined in each of two ends of each rack 32, and are connected to nuts 16.

The activation member 4 includes a pressing portion 40 which is movable in the first face groove 104 of the first part 10 and the second face groove of the second part 11. The activation member 4 has the restriction member 41 and two pawls 410 which are respectively engaged with the two toothed portions 320 of the driving unit 3. The restriction member 41 is made by flexible material, preferably, the restriction member 41 is an elongate and flexible strip.

The sleeve 5 includes a passage 50 in which the shaft 6 is located. Two elongate holes 51 are defined through a wall of the sleeve 5 and communicate with the passage 50. The driving portions 302 of the driving unit 3 can insert through the elongate holes 51. Two lugs 52 respectively extend from the sleeve 5 and the arms 7 are respectively connected to the lugs 52. Preferably, each of the lugs 52 includes a pivotal hole 520 and the first end of each of the arms 7 is pivotable about the pivotal hole 520 corresponding thereto. Specifically, the pivotal portion 70 of each arm 7 is a hole, and a pivot 55 extends through the pivotal hole 520 and the pivotal portion 70 to pivotably connect the arm 7 to the lug 52. Two clips 56 are engaged with two engaging grooves 550 defined in two ends of the pivot 55 to position the pivot 55.

The shaft 6 movably extends through the passage 50 of the sleeve 5 and includes a shank 60 with spiral teeth 61 formed on the shank 60.

The arms 7 each have a pivotal portion 70 formed in the first end thereof, and the first end of each arm 7 pivotably connected to the lug 52 of the sleeve 5 corresponding thereto. Multiple teeth 71 are formed on the outside of the first end of each arm 7 and engaged with the spiral teeth 61 of the shaft 6 corresponding thereto. A lever is formed on the second end of each arm 7 and has an operation portion 72 which moves the clamp member 8 corresponding thereto. Specifically, the operation portions 72 of the two arms 7 each are a hole. A pin 85 extends through the operation portion 72 of each arm 7 and the bore 80 of each clamp member 8 to pivotably connect the arm 7 to the clamp member 8 corresponding thereto.

The clamp members 8 each have a bore 80 and the protruded portion of each arm 7 is pivotably engaged with the bore 80. Each clamp member 8 has two rails 81 and an extension portion 82 which extends downward from the clamp member 8. The extension portions 82 of the two clamp members 8 so as to clamp a board 99 therebetween. A tubular portion extends from each clamp member 8 and a guide hole 83 defined in the tubular portion.

The base 9 is fixed to a lower end of each of the first part 10 and the second part 11. The base 9 has holes 90 which are located corresponding to the holes 106 of the first part 10 and the holes 116 of the second part 11. The base 9 has two guide grooves 91 with which the rails 81 of each clamp member 8 is slidably engaged. The base 9 have ribs 92 which restrict the extension portions 82 of the clamp members 8 from moving inward. A spring 95 is biased between the base 9 and the shaft 6.

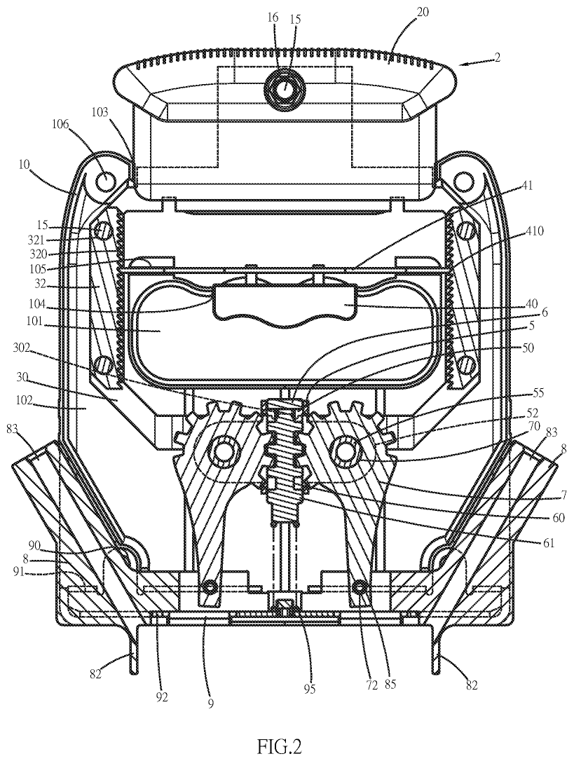

When in use, one of the user's hands extend through the first part 10 and the second part 11 and gripped. If the user tries to press the cover unit 2 first, because the pawls 410 of the activation member 4 are engaged with the toothed portions 320 of the two racks 32, so that the driving unit 3 cannot be moved downward as shown in FIG. 2. This design prevents the cover unit 2 to be unexpectedly pressed to widen the two clamp members 8.

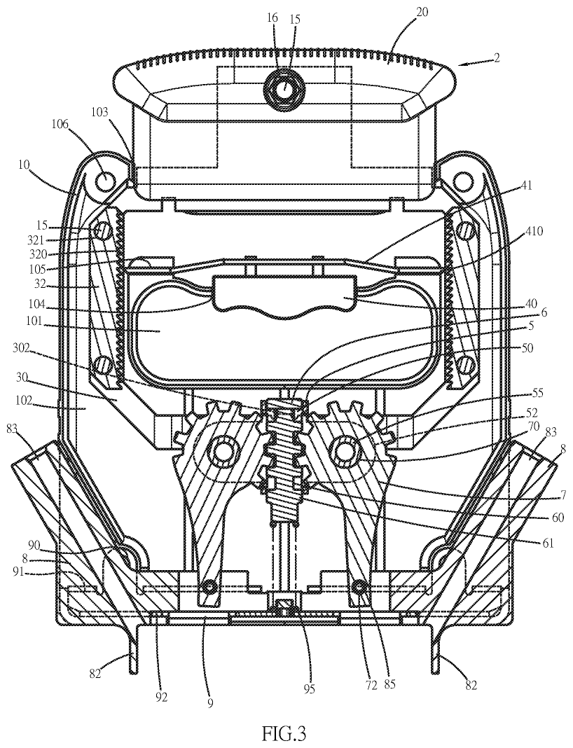

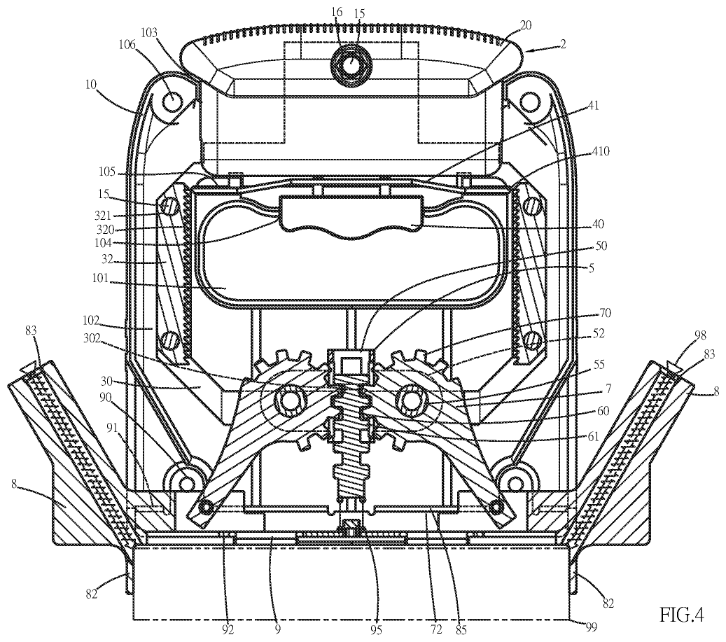

When the user's hand moves the activation member 4 toward the cover unit 2, the activation member 4 is slightly moved upward earlier than the cover unit 2, so that the restriction member 41 is slightly deformed and curved by the upward movement of the activation member 4, and the pawls 410 are retracted in the first positioning grooves 105 and the second positioning groove until the pawls 410 are shifted from the path that the toothed portions 320 of the two racks 32 move as shown in FIG. 3. Therefore, the cover unit 2 can be moved downward and drives the driving unit 3 to move downward. The shaft 6 in the passage 50 of the sleeve 5 is moved downward so that the spiral teeth 61 drives the teeth 71 of the arms 7, and the arms 7 are pivoted about the pivotal portions 70 so that the operation portions 72 move the rails 81 of the clamp members 8 to move along the guide grooves 91 of the base 9 until the extension portions 82 of the clamp members 8 to move to two sides of the board 99. If no further force is applied to the activation member 4 and the cover unit 2, the spring 95 will move the shaft 6 upward and forces the arms 7 to pivot in opposite direction. Therefore, the clamp members 8 are moved in opposite direction until the extension portions 82 of the clamp members 8 clamp the two sides of the board 99 so that the guide holes 83 are aligned with the corners of the board 99 as shown in FIG. 4. The bolts 98 are then introduced into the guide holes 83 and secure the board 99. Therefore, the distance of the two extension portions 82 is the maximum distance and can be used for the boards 99 of different widths.

While we have shown and described the embodiment in accordance with the present invention, it should be clear to those skilled in the art that further embodiments may be made without departing from the scope of the present invention.

What is claimed is:

1. An adjusting and positioning device comprising:
a first part having a first slot configured for manual gripping by a user' hand, a first space defined in the first part and a driving unit movably located in the first space, a first top groove defined in an outside of the first part and communicating with the first space, a cover unit movably engaged with the first top groove, a first face groove defined in the first part and communicating with the first space and the first slot, an activation member movably located in the first face groove, the activation member having a restriction member which is movable located in two first positioning grooves defined in the first part, the first part having a hole defined through each of four corners thereof;
a second part connected to the first part so that a portion of the cover unit, the driving unit, a portion of the activation member, a sleeve, a shaft, two arms, two clamp members and a base are accommodated between the first and second part, the second part being shaped and structured symmetrical to the first part and including a second slot configured for manual gripping by a user' hand, a second space defined in the second part and the driving unit movably located in the second space, a second top groove defined in an outside of the second part and communicating with the second space, the cover unit movably engaged with the second top groove, a second face groove defined in the second part and communicating with the second space and the second slot, the activation member movably located in the second face groove, the restriction member of the activation member movably located in two second positioning grooves defined in the second part, the second part having a hole defined through each of four corners thereof;
the cover unit having one end thereof movable between the first top groove of the first part and the second top groove of the second part;
the driving unit including multiple positioning holes defined in one end thereof so as to be connected to the cover unit, the driving unit having a driving portion protruding from the other one of the driving unit so as to drive the shaft in the sleeve, two toothed portions respectively formed in the driving unit so as to be engaged with the activation member;
the activation member having a pressing portion which is movable in the first face groove of the first part and the second face groove of the second part, the activation member having two pawls which are respectively engaged with the two toothed portions of the driving unit;
the sleeve having a passage in which the shaft is located, two elongate holes defined through a wall of the sleeve and communicating with the passage, the driving portions of the driving unit inserted through the elongate holes, two lugs respectively extending from the sleeve and the arms respectively connected to the lugs;
the shaft movably extending through the passage of the sleeve and including a shank with spiral teeth formed on the shank;
the arms each having a pivotal portion formed in a first end thereof, the first end of each arm pivotably connected to the lug of the sleeve corresponding thereto, multiple teeth formed on an outside of the first end of each arm and engaged with the spiral teeth of the shaft corresponding thereto, a lever formed on a second end of each arm and having an operation portion which moves the clamp member corresponding thereto;
the clamp members each having a bore and the protruded portion of each arm being pivotably engaged with the bore, each clamp member having two rails and an extension portion which extends downward from the clamp member, the extension portions of the two clamp members adapted to clamp a board therebetween, a tubular portion extending from each clamp member and a guide hole defined in the tubular portion;
the base fixed to a lower end of each of the first part and the second part 11, the base having holes which are located corresponding to the holes of the first part and the holes of the second part, the base having two guide grooves with which the rails of each clamp member is slidably engaged, the base having ribs which restrict the extension portions of the clamp members from moving inward, a spring biased between the base and the shaft;
when the first part and the second part are gripped via the first slot and the second slot, the activation member is moved upward to shift the restriction member away from a path that the toothed portions of the driving unit, the cover unit is pressed to move the driving unit to push the shaft so that the spiral teeth of the shaft drives the teeth of the arms so that the arms are pivoted, and the operation portions on the levers of the two arms drive the clamp members to move along the guide grooves of the base so as to control a distance between two adjacent boards by one hand.

2. The adjusting and positioning device as claimed in claim 1, wherein each of the lugs includes a pivotal hole and the first end of each of the arms is pivotable about the pivotal hole corresponding thereto.

3. The adjusting and positioning device as claimed in claim 2, wherein the pivotal portion of each arm is a hole, a pivot extends through the pivotal hole and the pivotal portion to pivotably connect the arm to the lug, two clips are engaged with two engaging grooves defined in two ends of the pivot.

4. The adjusting and positioning device as claimed in claim 1, wherein the operation portions of the two arms each are a hole, a pin extends through the operation portion of each arm and the bore of each clamp member to pivotably connect the arm to the clamp member corresponding thereto.

5. The adjusting and positioning device as claimed in claim 4, wherein multiple bolt respectively extend through the first holes of the first part and the second holes of the second part, and are connected with nuts to connect the first part to the second part.

6. The adjusting and positioning device as claimed in claim 5, wherein the driving unit includes two elongated racks and two identical frames, multiple plastic washers are clamped between the rack and the frame, each frame has the positioning holes and the driving portion which extends inward therefrom, each rack includes the toothed portion formed in an inner side thereof, and an aperture is defined through each of two ends of the rack, each plastic washer includes a central hole, the two racks and the sleeve are located between the two frames, the bolts extend through the positioning holes of the two frames, the central holes of the plastic washers and aperture defined in each of two ends of each rack, and are connected to nuts.

7. The adjusting and positioning device as claimed in claim 6, wherein the cover unit includes two identical covers, each cover includes a fixing hole which is located corresponding to the positioning hole of the driving unit, a bolt extends through the fixing holes and the positioning holes and are connected to a nut to connect the two covers with the driving unit.
